(19) United States
(12) Patent Application Publication
(10) Pub. No.: US 2016/0311265 A1
(43) Pub. Date: Oct. 27, 2016

(54) TREAD BAND HAVING CURVED BLOCKS WITH COVERING MATERIAL

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventor: Shuichi KANEKO, Tokyo (JP)

(73) Assignees: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(21) Appl. No.: 15/104,677

(22) PCT Filed: Dec. 15, 2014
(86) PCT No.: PCT/EP2014/077713

§ 371 Date: Jun. 15, 2016

(30) Foreign Application Priority Data
Dec. 17, 2013 (FR) 1362800

(51) Int. Cl. B60C 11/13; B60C 11/03; B60C 11/12; B60C 11/00

(52) U.S. Cl. CPC B60C 11/1346; B60C 11/0041; B60C 11/0302; B60C 11/1236; B60C 2011/1245

(57) ABSTRACT

The disclosure concerns a tread band made of rubber-like material for a tire, said tread band including two sides with a predetermined distance D between these two sides and a center. The tread band having a plurality of blocks, each block extending continuously in a curved manner to one side of the tread band towards the center of this tread band, the block following a certain curvature C. Each block includes at least one lateral face, this lateral face is covered totally by a covering material, the covering material having a modulus of elasticity which is greater than the modulus of elasticity of the rubber-like material forming the block.

### CROSS-REFERENCE TO RELATED APPLICATIONS

This application is a 371 national phase entry of PCT/EP2014/077713, filed 15 Dec. 2014, which claims the benefit of French Patent Application No. 1362800, filed 17 Dec. 2013, the contents of which are incorporated herein by reference for all purposes.

### BACKGROUND

The present disclosure relates to a pneumatic tire suitable for ice-bound or snow covered roads, and more particularly to a pneumatic tire for ice-bound or snow covered roads, in which the tread band of the pneumatic tire comprises a plurality of curved blocks.

Document U.S. Pat. No. 4,057,089 discloses a pneumatic tire comprising a tread band. The tread band has a plurality of blocks. Each block extends in a curved manner to one side of the tread band towards the center of this tread band. These curved blocks are defined by main grooves. These main grooves are able to drain water outside the tread band when the pneumatic tire is roiling on wet road. The curved blocks are here connected together via a large circumferential block which maintains the resistance of the different curved blocks in the tread band, limiting the risks of tearing of the rubber.

It is an object of the present disclosure to improve the adherence on a wet road of a tread band comprising a plurality of curved blocks and in the same time maintaining or improving the lifetime of this tread band.

“Tire” is understood as any type of elastic tire whether it is subjected to an internal pressure or not.

“Tread” of a tire is understood as a quantity of rubber material defined by lateral surfaces and by two principal surfaces, one thereof being designed to come into contact with a road surface when the tire is travelling.

“Block” is understood as relief element limited by some grooves. Each block comprises a plurality of lateral faces and a contact face which is able to come into contact with the road when the tire is rolling.

“Side of the tread band” is understood as the place in the pneumatic tire where a transition of the tread band with a side of the pneumatic tire occurs.

“Groove” is understood as a cut-out, the material faces thereof not coming into contact in normal travelling conditions. Generally, the width of a groove is greater than or equal to 2 mm.

“Sipe” is understood as a cut-out, the material faces thereof coming into contact during normal travelling conditions Generally, the width of a ripe is less than 2 mm.

### SUMMARY

The disclosure relates to a tread band made of rubber-like material for a tire. The tread band comprises two sides with a predetermined distance D between these two sides and a center. The tread band having a plurality of blocks, each block extending continuously in a curved manner to one side of the tread band towards the center of this tread band, the block following a certain curvature C. Each block comprises at least one lateral face, this lateral face is covered totally by a covering material. The covering material has a modulus of elasticity which is greater than the modulus of elasticity of the rubber-like material forming the block.

In the disclosure, the tread band is not provided with a central circumferential block. Thus, the ability of the tread band to drain water outside this tread band is improved. By using a covering material on the lateral faces of the blocks, it is possible to increase the stiffness of these blocks, thus compensating the lack of a central circumferential block in the tread band.

In a variant, the covering material comprises an elastomeric material of which the dynamic shear modulus G* subjected to a maximum alternating stress of 0.7 MPa, at a frequency of 10 Hz and at a temperature of −10°C., is greater than 200 MPa and preferably greater than 300 MPa.

By using a covering material with such features, we improve the ability of the block to scrap the snow on the road. Consequently, the adherence on a snow road is improved.

In a variant, the covering material comprises an assembly of fibers.

By using fibers, we improve the resistance of the covering material.

In a variant, all or part of the blocks of the plurality of blocks comprising a main sipe extending in the block and following the same curvature C, this main sipe separating the block in two ½ parts.

By using a covering material, in one hand the rigidity of the block is improved but in the second hand, the mechanical resistance of the block to the wear could be less important, By using a main sipe extending in the block, we compensate the increasing of the rigidity due to the cover material. Indeed, we create added edges on the block to improve the scraping of the tread band on the snow.

In a variant, the block comprises a plurality of secondary sipes, each secondary sipe extending perpendicularly to the main sipe.

We more decrease the rigidity of the block. Indeed, we create added edges to improve the scraping of the tread band on the snow.

In a variant, the pitch between the plurality of secondary sipes is globally equal along the main sipe.

The uniformity in the wear of the block is improved.

In a variant, each block having lateral walls, the secondary sipes do not extend until one of the lateral walls of the block.

We avoid the propagation of cracks inside the block.

In a variant, the main sipe having a depth of main sipe and the secondary sipes having the depth of secondary sipes, the depth of the secondary sipes is different than the depth of the main sipe.

Thus it is possible to adjust more precisely the rigidity in the block.

### BRIEF DESCRIPTION OF THE DRAWINGS

Other features and advantages of the disclosure will emerge from the following description, given by way of nonlimiting example, with reference to the attached drawings in which:

FIG. 1 schematically depicts a part of a tread band according to the disclosure;

FIG. 2 schematically depicts a block of the tread band of FIG. 1 according to a second embodiment of the disclosure;

FIG. 3 schematically depicts a block of the tread band of FIG. 1 according to a third embodiment of the disclosure.

### DETAILED DESCRIPTION

to the description that follows, elements that are substantially identical or similar will be denoted by identical references.

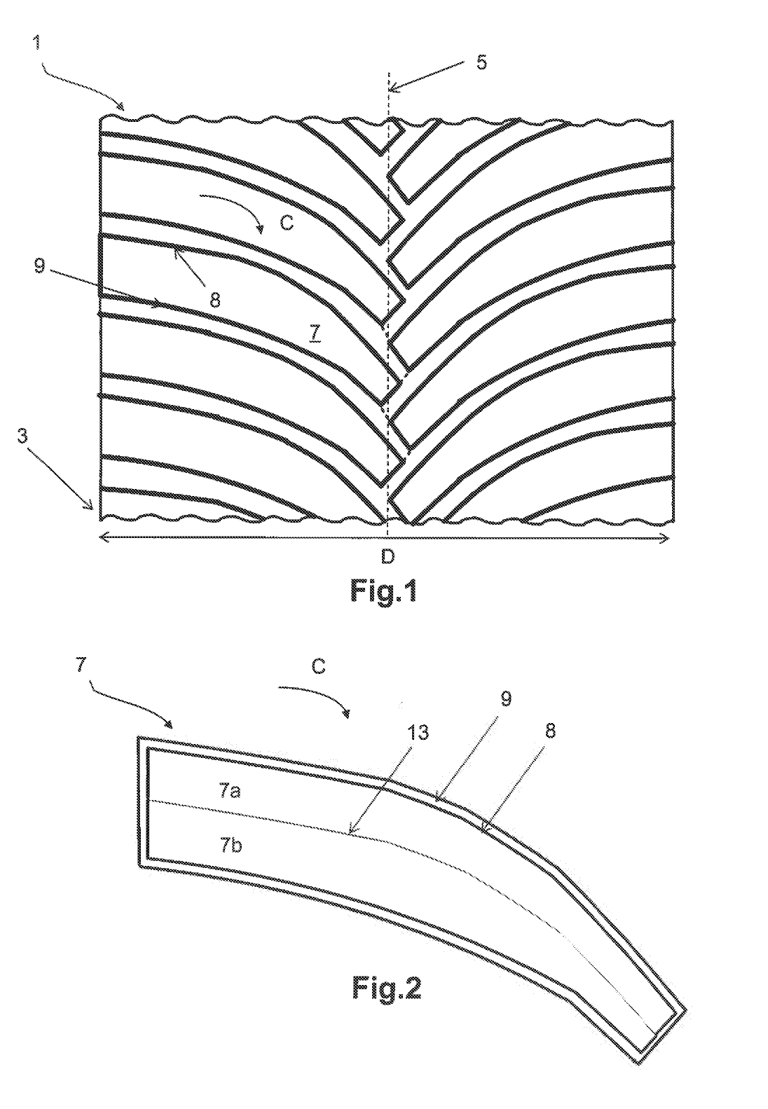

FIG. 1 depicts a tread band 1 made of rubber-like material for a tire. The tread band 1 comprises two sides 3 and a center 5. The distance D between the two sides 3 of the tread band is disclosed by the European Tire and Rim Technical Organization (ETRTO). The ETRTO defines this distance D such as D=(1.075-0.005 ar)*S^{1.001}, where ar is the Nominal aspect ratio and S is the Design Section Width on Measuring Rim. The tread band has a plurality of blocks 7 defined by main grooves, Each block extends continuously in a curved manner to one side 3 of the tread band towards the center 5 of this tread band, the block following a certain curvature C. By “continuously”, it is understood that no secondary groove opening into the main grooves separate the block in different parts. With no secondary groove opening into the main grooves, the evacuation of the water outside this tread band, via the main grooves, is not disturbed. By “towards the center”, it is understood that the block stops at the level of the center, or just before the center or just after the center. The center means a line extending in a circumferential direction and dividing the tread band in two equally parts of the tread bands. The blocks are here not connected together in the center of the tread band.

Each block comprises lateral faces 8, the lateral faces being covered totally by a covering material 9, This covering material has a modulus of elasticity which is greater than the modulus of elasticity of the rubber-like material forming the block 7.

More particularly, the covering material comprises an elastomeric material of which the dynamic shear modulus G* subjected to a maximum alternating stress of 0.7 MPa, at a frequency of 10 Hz and at a temperature of −10° C., is greater than 200 MPa and preferably greater than 300 MPa. in the present document, the terms “modulus of elasticity G′” and “modulus of viscosity G″” denote the dynamic properties well known to the person skilled in the art. Said properties are measured on a Metravib VA4000 viscoanalyser on test specimens molded from raw compositions. Test specimens such as those described in the ASTM D 5992-96 standard (version published September 2006, initially approved in 1996) in the figure X2.1 (circular embodiment) are used. The diameter of the test specimen is 10 mm (thus it has a circular section of 78.5 mm²), the thickness of each of the portions of rubber-like composition is 2 mm, which provides a “diameter to thickness” ratio of 5 (in contrast to the ISO 2856 standard, cited in the ASTM standard, paragraph X2.4 which recommends a d/t value of 2). The response of a test specimen of a vulcanized rubber-like composition subjected to simple alternating sinusoidal shear stress, at a frequency of 10 Hz, is recorded. The test specimen is subjected to sinusoidal shear stress at 10 Hz, at controlled stress (0.7 MPa) symmetrically around its position of equilibrium. The measurement is carried out during a temperature ramp increasing by 1.5° C. per minute, from a temperature Tmin lower than the glass transition temperature (Tg) of the material, up to a temperature Tmax which may correspond to the rubber plateau of the material. Before starting the scanning, the test specimen is stabilized at the temperature Tmin for 20 minutes to reach a uniform temperature within the test specimen. The result used is the dynamic shear modulus of elasticity (G′) and the shear modulus of viscosity (G″) at the selected temperatures (in this case 0°, 5° and 20° C.). The “complex modulus” G* is defined as the absolute value of the complex sum of the modulus of elasticity G′ and the modulus of viscosity G″: G″={square root over (G′²+G″²))}.

In a variant, the elastomeric material of the covering layer comprises a composition based on at least one diene elastomer which is very highly laden with sulfur, such as ebonite.

In a variant, the covering material comprises an assembly of fibers, for example a three-dimensional assembly of fibers forming a felt. The fibers of said felt may be selected from the group of textile fibers and mineral fibers and a mixture thereof. It is also noteworthy that the fibers of said felt may be selected from textile fibers of natural origin, for example from the group of silk, cotton, bamboo, cellulose, wool fibers and mixtures thereof.

In a further variant, the elastomeric material of the covering layer comprises a composition based on at least one thermoplastic polymer, such as polyethylene terephthalate (PET). Such a polymer may have a Young's modulus of more than 1 GPa.

FIG. 2 depicts a block of the tread band according to a second embodiment of the disclosure. In this embodiment, all of the blocks 7 comprise a main sipe 13 extending in the block and following the curvature C. The main sipe separates the block in two ½ parts 7a 7b, this two ½ parts 7a, 7b being globally the same. In a variant, only a part of the blocks 7 comprises the main sipe 13.

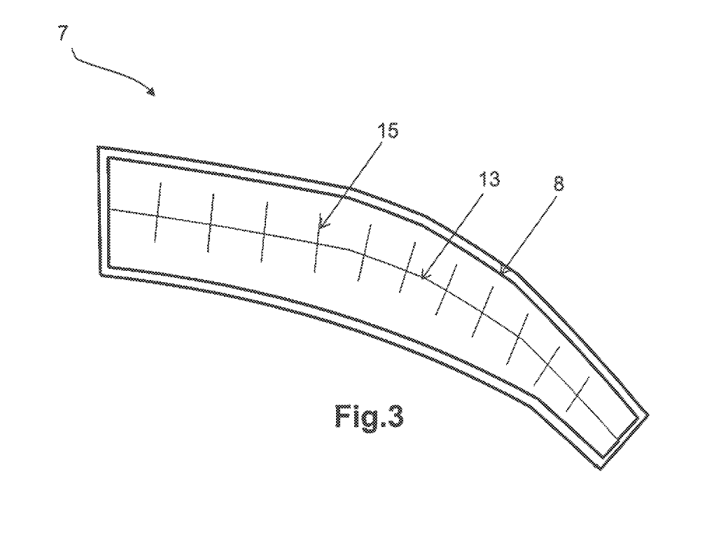

FIG. 3 depicts a third embodiment in which the block comprises a plurality of secondary sipes 15, each secondary sipe extending perpendicularly to the main sipe 13. The depth of the secondary sipes 15 is globally equal to the depth of the main sipe 13. In a variant, the depth of the secondary sipes is different than the depth of the main sipe. For example, the depth of the secondary sipes is lower than the depth of the main sipe. All the combinations of depth between the main sipe and the secondary sipes are possible.

Indeed, the pitch between the plurality of secondary sipes 15 is globally equal along the main sipe 13.

In addition, the secondary sipes 15 do not extend until one of the lateral walls 8 of the block (7).

The disclosure is not restricted to the examples described and depicted and various modifications can be made thereto without departing from its scope.

1. A tread band made of rubber-like material for a tire, comprising:
two sides with a predetermined distance D between these two sides and a center,
a plurality of blocks, each of the plurality of blocks extending continuously in a curved manner to one side of the tread band towards the center of this, at least one of the plurality of blocks has a curvature C and each block includes at least one lateral face, the lateral face being covered entirely by a covering material, the covering material having a modulus of elasticity greater than the modulus of elasticity of the rubber-like material forming the block.

2. The tread band according to claim 1, wherein the covering material includes an elastomeric material of which the dynamic shear modulus G* subjected to a maximum alternating stress of 0.7 MPa, at a frequency of 10 Hz and at a temperature of −10° C., is greater than 200 MPa.

3. The tread band according to claim 1, wherein the covering material comprises an assembly of fibers.

4. The tread band according to claim 1, wherein all or part of the blocks of the plurality of blocks comprising a main sipe extending in the block and following the same curvature C, this main sipe separating the block in two 1/2 parts.

4. The tread band according to claim 4, wherein the block comprises a plurality of secondary sipes, each secondary sipe extending perpendicularly to the main sipe.

6. The tread band according to claim 5, the pitch (P) between the plurality of secondary sipes is globally equal along the main sipe.

7. The tread band according to claim 5, wherein the secondary sipes do not extend until one of the lateral face of the block.

8. Tread band according to claim 5, in which the main sipe has a depth of main sine and the secondary sipes have the depth of secondary sipes, characterized in that the depth of the secondary sipes is different than the depth of the main sipe.

9. The tread band according to claim 1, wherein the covering material includes an elastomeric material of which the dynamic shear modulus G* subjected to a maximum alternating stress of 0.7 MPa, at a frequency of 10 Hz and at a temperature of −10° C., being greater than 300 MPa.
